(19) United States
(12) Patent Application Publication
(10) Pub. No.: US 2002/0123956 A1
(43) Pub. Date: Sep. 5, 2002

(54) Method and system for creating and verifying derivative contract terms using party relationships

(76) Inventor: Albhy Galuten, Santa Monica, CA (US)

Correspondence Address: DARBY & DARBY, 805 THIRD AVENUE, 27TH FLR., NEW YORK, NY, 10022, US

(21) Appl. No.: 09/859,229

(22) Filed: May 16, 2001

Related U.S. Application Data
(60) Provisional application No. 60/204,484, filed on May 16, 2000.

(51) Int. Cl. G06F 17/60

(52) U.S. Cl. 705/37

(57) ABSTRACT

Method and system for determining and verifying derivative contracts from party relationships. Parties enter into exchange-of-value transactions by offer and acceptance of contract terms that provide for an exchange of value. Parties in these transactions are value chain participants, with a plurality of express and implied contractual relationships among the participants within the value chain. The present invention determines the derivative contract terms for offer and acceptance of exchange-of-value transactions based on relationships between value chain participants. Reference services derive the contract terms by determining the relationships between parties and then applying rules to these relationships in order to generate the contract terms. The present invention is particularly applicable in the area of e-commerce transactions, where a plurality of complex relationships creates complex business transactions. Thus, in the area of the purchase of audio and video content through electronic media, as well as the purchase of products via web sites, reference services are able to derive the contractual terms for such purchases and include them in a purchase agreement, thereby protecting the rights and duties of value chain participants that are involved in the transaction.

### RELATED APPLICATIONS

This application is based on and claims the priority of Provisional Application Serial No. 5 60/204,484, filed May 16, 2000, the contents of which are hereby incorporated herein by reference.

### FIELD OF THE INVENTION

The present invention generally relates to the field of electronic commerce. More specifically, this invention relates to a system for tracking commercial transactions, determining 10 offers to make to transaction parties based on the relationships between and among parties within the transactions, and verifying the terms of the transaction offers.

### BACKGROUND OF THE INVENTION

The fundamental principal of commerce is that parties will enter into transactions where there is an exchange of value, wherein each party perceives that the value received by the party is greater than the value relinquished by the party. Traditional exchange-of-value transactions include club membership with associated benefits for money or services, variable shipping rates in exchange for different shipping delays, marketing and promotion in exchange for greater exposure and sales, discounted products in exchange for new or loyal customers, privacy in exchange for money, and money in exchange for goods or services. In the area of e-commerce, exchange-of-value transactions include the purchase of information and the right to access information via purchase, and licensing agreements for electronic information including audio, video and other electronic media content. These and other exchange-of-value transactions essentially require two or more parties with a relationship between the parties that determines the acceptable terms of the exchange-of-value transaction and the sources of the items or content exchanged.

In the present business world of complex transactions, a plurality of parties and relationships exist and affect the terms, conditions and fulfillment of an offer and acceptance to complete an exchange-of-value transaction. This causes a “value chain” for an exchange-of-value transaction, wherein a plurality of interrelated parties is part of an exchange-of-value transaction. These parties are value chain participants whose relationships with other parties in the value chain determine the terms, conditions and satisfaction of an exchange-for-value transaction. Thus, value chain participants include consumers, manufacturers, distributors, retailers, wholesalers, clubs, individuals, organizations, and other parties that have an explicit or implicit contractual relationship, and whose relationship determines the overall terms of an exchange-of-value contract. Value chain participants may be formally bound or related via preexisting contracts to certain relationships and obligations, and value chain participants may also be informally bound or related through mere association or common interests. Thus, not all value chain participants are necessarily formal parties to an exchange-of-value transaction, and yet the relationships between party and non-party value chain participants may affect the derivative terms of the exchange-of-value transaction.

These features of complex business transactions, exchange-of-value transactions, and value chains that include parties and relationships to an exchange-of-value transaction are particularly prominent in e-commerce transactions. In e-commerce transactions, a number of factors bears on the individual exchange-of-value offers and acceptances, thereby consummating a plurality of exchange-of-value transactions. The terms of each individual exchange-of-value transaction are affected by the individual relationships and the terms that define those relationships between the value chain participants that affect the exchange-of-value transaction.

In addition, the large number of electronic distributors of audio and video content result in a complex chain of interrelated parties including consumers, retailers and distributors that incur certain contractual obligations when access to or possession of electronic information is purchased in an exchange-of-value transaction.

As an example of an exchange-of-value transaction in an e-commerce context, a consumer may desire to download music from the Internet and thereby enter into a contract with an Internet music club. This establishes a relationship between the consumer and their club based on the terms of the contractual agreement between the consumer and the club. The club in turn may have a separate contractual agreement with one or more music distributors, which establishes a relationship between the club and the distributors based on the terms of the different distributor-club contracts. This consumer-club-distributor succession of relationships establishes a value chain that determines the terms of an offer to purchase music for the consumer. Manufacturers or distributors may offer music to the club at specific prices, which are then modified based on the consumer's club subscription agreement. When an offer to purchase music is sent to the user, it is typically based on the terms of prior contractual relationships between value chain members as well as the general relationships between value chain members. If the offer to purchase music is accepted by the consumer, then the distributor must electronically deliver the music purchased to the consumer. Alternatively, the consumer may merely purchase the right to access or listen to music without the right to actually possess the music content. Again, the consumer-club-distributor value chain will determine the terms and conditions of such a purchase as well as the obligations of the distributor upon completion of the exchange-of-value transaction.

For both general commerce and more specifically e-commerce, it is desirable for the terms of an exchange-of-value offer, acceptance and transaction to be determined according to the relationships between value chain members and the terms of the agreements that define their relationships. In particular, it is desirable to determine a derivative contract, whose terms and conditions are based upon the relationships between value chain members and the terms that define those relationships. For example, in the e-commerce context, it is desirable to determine the derivative terms for an exchange-of-value transaction between a consumer and a manufacturer or distributor based on both the direct relationship the consumer has with the manufacturer or distributor, and also based on any antecedent or intermediate relationships between the consumer, manufacturer, distributer and other value chain participants.

By determining the terms of a derivative contract based on a value chain and its value chain participants, value chain participants are able to enter into new exchange-of-value transactions that benefit the value chain participants. For instance, once the terms of a derivative contract between value chain participants are determined, then one of the value chain participants can make an offer for a contract with those derivative terms to another value chain participant. The recipient can then accept the terms of the derivative contract to consummate a new exchange-of-value transaction that benefits both parties to the transaction. Thus, consumers, manufacturers, distributors, retailers, wholesalers, clubs, individuals, organizations and other parties who are value chain participants may enter into new exchange-of-value transactions that benefit these parties.

Without the ability to determine the derivative terms of an exchange-of-value transaction based on the relationships and terms thereof between value chain participants, a number of problems occur. First, it is difficult to determine the precise terms and conditions for complex business transactions where numerous legal rights and duties, incentives and other dynamics determine the terms of transactions for particular parties. Second, it is difficult to identify particular value chain participants that should be awarded or are entitled to different terms based on complex considerations that include the motives and incentives of different parties. Third, without the ability to determine the terms of an exchange-of-value transaction based on prior relationships and their terms, there is a lower probability that a new exchange-of-value transaction will be consummated because offers will not be tailored according to the individual characteristics of value chain participants. Fourth, without the ability to determine the terms of an exchange-of-value transaction based on prior relationships and their terms, there is a strong possibility that the terms of the new exchange-of-value transaction will violate one or more of the legal duties and obligations between the value chain participants as defined by the terms of their relationships. Fifth, even when the exchange-of-value terms may be confidently derived from complex business relationships and their legal obligations, determining these terms may be complex, cumbersome and inefficient based on the broad diversity of producers and consumers and their individual relationships within the value chain web.

These problems regarding the derivative determination of exchange-of-value transaction terms based on value chain participant relationships and their terms are particularly acute in the area of e-commerce, wherein a premium is placed on the placement of quick and accurate exchange-of-value transactions in the context of complex relationships and terms between parties. In the e-commerce context, it is desirable to quickly, efficiently and automatically determine the terms of exchange-of-value transactions, particularly where the content of the transaction is information or access to information such as audio and video content.

### SUMMARY OF THE INVENTION

These and other problems with determining the terms of offer, acceptance and transaction for exchange-of-value transactions are addressed by the present invention, which is a method and system for creating and verifying derivative contract terms based on value chain participant relationships. The present invention first determines the relationships between different value chain participants, including the terms and obligations of agreements between the value chain participants, which reflect the participants' agreed to exchange of value. The present invention then processes this information using a plurality of derivation rules that operate on the data to determine what the terms of the new contract should be. This process thereby creates the terms for a new exchange-of-value transaction for a party to propose an exchange-of-value transaction. The derivative terms for the new exchange-of-value transaction are then presented as an offer that may be accepted or rejected by the offer's recipient. If the offer is accepted, an exchange-of-value transaction is consummated and the parties receive the mutual benefit of the transaction according to its terms. The offer may be an offer to purchase or an offer to sell, and may be initiated by either purchaser or seller, depending on the particular circumstances.

Similarly, the present invention can also verify the terms for a new exchange-of-value transaction for a party who receives an exchange-of-value offer. In this mode, an offer recipient receives an offer for an exchange-of-value transaction from another value chain participant. The present invention then determines the relationships between different value chain participants, including the terms and obligations of agreements between the value chain participants, which reflect the participants' agreed to exchange of value. The present invention processes this information using a plurality of derivation rules that operate on the data to determine what the terms of the new contract should be. This information is presented to the recipient as a verification of the offer, which is compared to the terms of the offer and used by the recipient to determine if the terms of the exchange-of-value offer are in accord with the relationships between the value chain participants. The recipient is then able to accept the offer, reject the offer or present a counter offer based on the verification information generated by the present invention.

The examination of relationship data, application of derivation rules to the data, and determination of exchange-of-value transaction terms is performed by one or more reference services. Reference services include rules engines and relationship data that define the explicit or implicit relationship between value chain participants and determine the terms for exchange-of-value transactions. Each reference service may include both relationship data, which define the relationships between and among value chain participants including legal obligations and incentives, and a rules engine that operates on relationship data and reference data to determine the terms for an exchange-of-value transaction. Each value chain participant may have its own reference service, or a single reference service may serve a plurality of value chain participants.

Relationship data may be included at each reference service, or may be requested and received from other sources external to the reference service. Reference data is data that is generated by, requested from, and received from other reference services, and is thereby created by those references services using their own rules engines. Thus, other reference services may operate on their own relationship data and reference data from other references services to generate reference data. This reference data may then be requested by and sent to other reference services to be operated on by their rules engines.

A rules engine may also be included at each reference service. The rules engine determines the terms for an exchange-of-value transaction based on the relationship data and reference data. Each rules engine includes the derivation rules, which are applied to the relationship data and reference data to determine the exchange-of-value transaction terms. The derivation rules may include both static rules that remain constant over time and dynamic rules that vary according to the particular relationship data and reference data. As an illustration of a static rule, all value chain participants may receive a certain discount for a particular product. As an illustration of a dynamic rule, a value chain participant may receive an additional discount based on their status as a long-time customer, for spending above a certain threshold amount of money, and based upon other individual characteristics that determine which derivation rules apply to the value chain participant.

In addition, rules engines may themselves reconfigure the derivation rules according to the rules engines' configuration data. Thus, the derivation rules as applied through the rules engine on the relationship data and reference data determine the exchange-of-value terms for an offer or acceptance. In this way, a party can use their reference service to establish the terms of an exchange-of-value offer to another party. Similarly, the recipient of the offer can use their reference service to determine whether or not to accept an offer of another party.

By determining the terms of an exchange-of-offer transaction using a reference service, the prior problems concerning complex business transactions, particularly in the area of e-commerce, are addressed. First, it is possible to determine the precise terms and conditions for an exchange-of-value transaction for complex business transactions where numerous legal rights and duties, incentives and other dynamics apply to the parties. Second, it is possible to identify particular value chain participants that should be rewarded or are entitled to different terms by examining the relationship data for those parties. Third, there is a higher probability that an exchange-of-value transaction will successfully be consummated because the offer and the acceptance will reflect prior agreements and relationships between parties and thereby more accurately predict the acceptable terms of new exchange-of-value transactions between the parties. Fourth, deriving the exchange-of-value terms from the existing legal duties and obligations between value chain participants ensures that these duties and obligations will be upheld. Fifth, derivation of the exchange-of-value terms is accurate, efficient and automatic despite the complex relationships between parties.

In the context of e-commerce, the relationship data that defines the relationships between value chain participants includes electronic contracts between value chain participants. Each electronic contract includes a data structure of relationship data that defines the relationships between and among value chain participants. Reference services operate on these electronic contracts using their rules engines to determine the exchange-of-value transaction terms. Each electronic contract may include relative terms that define the relationship between two or more value chain participants. Each electronic contract may also include absolute terms that define conditions and limits of contracts for a particular value chain participant, irrespective of its relationships with other value chain participants.

Reference services may be implemented in server systems and computing systems that communicate with value chain participants and other reference services via means such as the Internet. Similarly, reference data and relationship may be created stored in a hard drive or other electronic storage medium for access by value chain participants and reference services. When the terms of an exchange-of-value transaction are determined by one or more reference services, these terms may also be sent via the Internet or other electronic media. Completed exchange-of-value transactions that occur via reference services may also notify value chain participants regarding the completion of the transaction, thereby automatically prompting value chain participants to make payment, deliver a product, and take other steps to satisfy the terms and conditions of the exchange-of-value transaction. Finally, electronic media that are the subject of the exchange-of-value transaction may itself be delivered via the Internet or other electronic communication means, thereby allowing instantaneous delivery and access of information upon completion of the exchange-of-value transaction.

Rules engines include software applications that process and operate on electronic contracts and reference data to create value chain management objects. Value chain management objects include the exchange-of-value terms for a new contract. Each value chain management object includes a plurality of value chain data pointers that point to particular value chain participants and terms. Thus, a value chain data pointer may point to a particular product or term, which when referenced, determines the actual content of that product or term. For instance, a value chain data pointer may point to a particular song, which when referenced, reveals the song's price, distributor or period of availability. These and other contractual terms may be included as pointers within a value chain management object.

Value chain management objects that are generated by rules engines may be forwarded to other reference services, sent as an offer to the end party, or used by a party accessing the reference service to evaluate an offer already received. The terms of the value chain management object are defined by its content, including the value chain data pointers included in the value chain management object. By forwarding value chain management objects to other reference services, reference services are able to access each other's information in an arbitrarily complex and dereferenced manner to exchange relationship information, reference information and contractual terms.

As implemented in software, a value chain management object is a data object that includes pointers to its content. Thus, the content of the value chain management object, and hence its terms, are defined by those pointers and data that are included as part of the value chain management object. As a value chain management object passes from one reference service to another, each reference service may add additional reference data pointers and information to add to the content, and hence terms, of the value chain management object. When a value chain participant receives a value chain management object, the participant then dereferences the reference data pointers included in the value chain management object to determine the content of the value chain management object.

When a customer engages in a transaction with another value chain participant, the customer first presents himself as a value chain participant using a value chain data pointer. The 5 other value chain participant then queries their reference service, which determines that the customer has relationships with other value chain participants. The customer's reference service queries the other reference services for those other value chain participants, which present themselves to the customer's reference service via additional value chain data pointers. These value chain data pointers include information about the terms of the exchange-of-value transaction to be entered into with the customer, and are packaged as a value chain management object by the customer's reference service. The reference service then sends this value chain management object to the customer, who may then examine the terms of the value chain management object and determine whether or not to accept the terms of the exchange-of-value transaction.

### BRIEF DESCRIPTION OF THE DRAWINGS

The foregoing and other features of the present invention will be more readily apparent from the following detailed description and drawings of illustrative embodiments of the invention in which:

FIG. 1 is a block diagram illustrating the value chain management object system;

FIG. 2 is a block diagram illustrating the use of a content reference and offer management architecture;

FIG. 3 is a table of the reference data pointers;

FIG. 4 is a block diagram illustrating the use of super distribution of value chain management objects;

FIG. 5 is a table of the product identifiers;

FIG. 6 is a table of the value chain identifiers;

FIG. 7 is a block diagram illustrating the aggregation of services;

FIG. 8 is a block diagram illustrating the use of value chain information in a commercial transaction;

FIG. 9 is a block diagram illustrating the use of value chain information in a commercial transaction using affinity, retail, service and portal management; and

FIG. 10 is a block diagram illustrating the use of value chain information in a commercial transaction that includes an offer and an acceptance of the offer.

### DETAILED DESCRIPTION OF THE PREFERRED EMBODIMENTS:

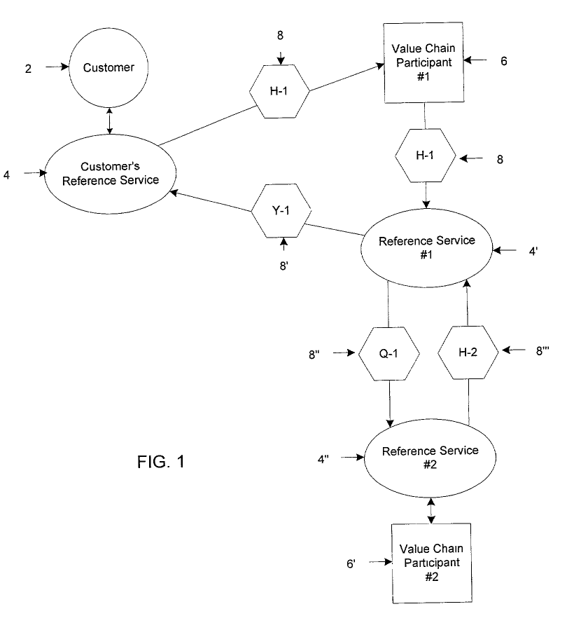

FIG. 1 is a block diagram illustrating the value chain management object system. This is the system wherein a value chain management object is created by a reference service that determines the terms and conditions of a value chain management object.

Referring now to FIG. 1, a customer 2 first presents himself to a first value chain participant 6 through the customer's reference service 4 using a reference data pointer 8, which is generated by the customer's reference service 4. The reference data pointer 8 includes the query information that the customer's reference service 4 is seeking for a new exchange-of-value transaction. Thus, the customer 2 queries other value chain participants by communicating with their customer reference service 4, which generates a reference data pointer 8 that is sent to other value chain participants and their reference services.

The first value chain participant 6 receives the customer's reference data pointer 8 and then queries its own reference service 4′ using the customers reference data pointer 8. The first reference service 4′ thereby fields the query of the customer 2 and attempts to provide the exchange-of-value transaction information that is requested in the customer's reference data pointer 8. The reference service 4′ determines that the customer 2 has a relationship with a second value chain participant 6′ by examining its relationship data as well as other reference data the first reference service 4′ receives from other reference services. Thus, the first reference service 4′ determines that it should query a second reference service 4″ for additional information related to the customer's query based on the relationship between the customer 2 and the second value chain participant 6′.

The first reference service 4′ may also determine that is own value chain participant 6 has a relationship with the second value chain participant 6′ that bears on the customer's query. Thus, the first reference service 4′ may determine that it should query the second reference service 4″ for additional information that relates to the customer's query based on the relationship between the first value chain participant 6 and the second value chain participant 6′.

The first reference service 4′ proceeds to query the reference service 4″ for the second value chain participant 6′ using a second reference data pointer 8″. The second reference data pointer 8″ differs from the customer's original reference data pointer 8 in that it includes additional information for the query of the first reference service 4′ as well as the customer's reference service 4. Thus, the second reference data pointer 8″ builds upon the first reference data pointer 8 to request any additional information necessary to satisfy the customer's query for an exchange-of-value transaction.

Upon receipt of the second reference data pointer 8″, the second reference service 4″ presents itself to the first reference service 4′ using a reference data pointer 8′″, thereby providing the first reference service 4′ with relevant information about the relationship between the second value chain participant 6′ and the consumer 2. This reference data pointer 8′″ includes information requested in the reference data pointer 8″ sent from the first reference service 4′ to the second reference service 4″, as well as any additional relevant information to be sent in response to the query by the reference data pointer 8″. Thus, the second reference service 4″ communicates with its value chain participant 6′ if necessary, and returns the exchange-of-value information that responds to the query from the reference data pointer 8″ to the first reference service 4′.

The first reference service 4′, now having the necessary relevant information to create and present a value chain management object to the customer 2, creates and presents the value chain management object as an offer to the customer 2. The first reference service 4′ may present the information it received from the second reference service 4″ in its original form, or the first reference service 4′ may filter the information received from the second reference service 4″ by using its rules engine to process the reference information received from the second reference service 4″. The original or filtered information may then be appended with any additional relevant information from the first reference service 4′ in response to the customer's reference data pointer 8, which is then presented to the customer's reference service 4 in the form of a reference data pointer 8′.

The reference data pointer 8′ received by the customer's reference service 4 from the first reference service 4′ includes the information in response to the customer's original reference data pointer 8. This information is in the form of an offer that reflects the relationships and obligations between the customer 2, first value chain participant 6 and second value chain participant 6′. In particular, the reference data pointer 8′ returned to the customer 2 includes information for an exchange-of-value offer as requested by the customer 2, and as such comprises a value chain management object that includes the terms of an offer to the customer 2 for an exchange-of-value transaction. Upon receipt of the offer in the form of the reference data pointer 8′, the customer 2 is able to determine if he or she wants to accept or reject the terms of the value chain management object, and thereby consummate or decline to enter into an exchange-of-value transaction.

As an illustration of the process described above, three value chain participants may include a customer, music club and music retailer. The customer may be in a relationship with the music club by which he receives a 10% discount on all music obtained from the music club. The music club in turn may be in a discount relationship with the music retailer as a purchaser of music from the retailer. Upon acquisition of a new release by the retailer, the retailer may query the reference service for the music club to determine its customers, and then query the reference service of the customers to determine if the new release is within the type of music purchased by the customer in past instances. If so, then the retailer queries and retrieves the terms of the relationship between the music club and the customer, including the 10% discount term, and generates an offer to sell the music at a 10% discount that is sent to the customer. The customer receives the offer as a value chain management object that includes reference data pointers gathered by the retailer's reference service, and is then able to determine whether or not to accept the offer made by the retailer. By querying the reference services for the music club and customers, the retailer's reference service is able to generate an offer tailored to the individual preferences and relationships between the retailer, the music club, and the parties in an automatic, efficient and targeted fashion.

Although in the example above the retailer initiates the offer that is sent to the customer, the customer is also able to request an offer through the method of the present invention by sending a query to the music club. The music club in turn queries all other relevant value chain participants, including the music retailer, and generates the terms of an offer in response to the customer's query. The customer then receives the terms of the offer and is able to accept or reject the offer. Thus, consumers, retailers and distributors within the value chain may initiate an offer that is sent to other value chain participants.

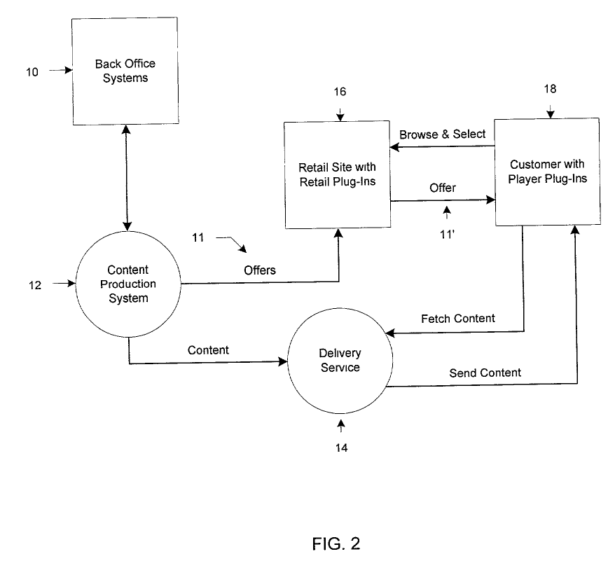

FIG. 2 is a block diagram illustrating the use of a content reference and offer management architecture. The content reference and offer management architecture is one implementation of the value chain management object system in the context of electronic audio content. In this architecture, reference services are utilized by distributors, which use their reference services to create offers. The value chain management objects created in this architecture include data pointers and offers. Reference data pointers include the raw data necessary to create an offer. It should be understood that the content reference and offer management architecture shown in FIG. 2 is not limited to audio content, but may also be used for video content and other general electronic information.

Offers created by reference services in the content reference and offer management architecture of FIG. 2 include reference data pointers that define the content and terms of the offer, as well as additional information necessary to exercise an offer for purchase of, renting of or subscription to the audio content. Additional information not included as reference data pointers may include standard, non-value-chain-specific terms and information, regardless of the particular value chain participants, and thus are not required to point to different reference data pointer values. Offers are created by reference services included at retailers or distributors, including single individuals and individual artists that act as their own distributor.

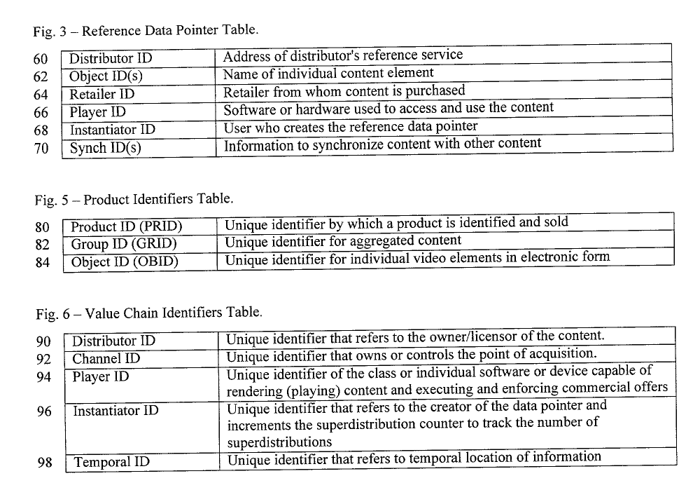

FIG. 3 shows the reference data pointers table, which includes the different types of reference data pointers used to create an offer for electronic content, including audio and video content, as used in the system of FIG. 2. As shown in FIG. 3, the distributor ID 60 includes the address of the electronic content distributor, and the object ID 62 includes the name of an individual electronic content element, such as a title, artist or name. The retailer ID 64 includes the identification for the retailer from whom the electronic content is purchased, and the player ID 66 includes the identification of the software or hardware used to access and play the electronic content. The instantiator ID 68 includes the identification of the user or value chain participant that creates the reference pointer, and the synchronization ID 70 includes the synchronization information necessary to synchronize the electronic content received with the electronic content in another location. A value chain management offer may include one or more of these reference data pointers as part of the exchange-of-value offer.

Referring now to the content reference and offer management architecture shown in FIG. 2, a plurality of offers 11 are first downloaded to a retail web site 16 or other electronic retail location from a content production system 12 that includes different audio content. A customer 18 then accesses the retail web site 16 and selects an offer 11′ from the offers 11 available at the retail site 16. The customer's browser recognizes the mime type for the audio content of the offer 11′ and launches an appropriate audio player for the audio content. The audio player allows the customer 18 to purchase the audio content selected, download the audio content for later access including purchase, pay-per-play or rent-to-own, and then listens to a stream of the audio content. Information about the audio content is communicated to the customer 18 through reference data pointers including those shown in FIG. 3. After the offer and its download choice is selected, the customer 18 fetches the audio content from the audio delivery service 14, which retrieves the content from the content production system 12 and sends the content to the customer 18. The content received may include a license or right to access the audio content, or the actual audio content stored with the customer 18. The customer 18 can thereby exercise his or her right to listen to the audio content anywhere, and if the audio content is lost it may be downloaded again without re-purchase.

In the context of the content reference and offer management architecture shown in FIG. 2, reference services are used to create or verify offers based on the contractual relationships between the customers, retailers and distributors within the value chain for these audio transactions. The reference services of retailers can query the reference services of distributors to create or validate offers in real time. In addition, parties may interact via individual reference services or collective reference services that manage offers between the parties.

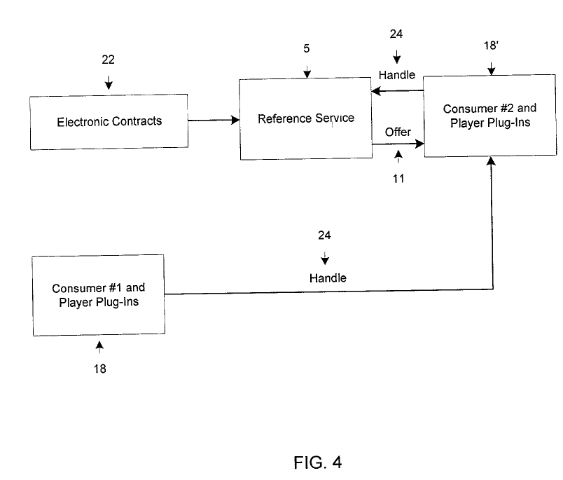

FIG. 4 is a block diagram illustrating the use of super distribution of value chain management objects. Super distribution occurs when a customer has the ability to redistribute to another consumer content they have acquired, who then has the option to purchase or rent the content received. Reference services are used to facilitate super distribution by tracking the content referrals by one customer to another and generating offers for purchase or rental to the recipient customers based on their receipt of the content. When one customer redistributes content to another customer, only the reference data pointers to that content are redistributed, rather than the content itself. Thus the holder of the content can control the access to the content by the recipient of the content while making an offer for continued access to the content by the recipient.

Referring now to FIG. 4, a first consumer 18 sends a reference data pointer 24 for audio content to a second consumer 18′, who accesses the reference data pointer 24 to launch their audio player. If the second consumer 18′ already has the audio content, then the audio content will simply play because the second consumer 18′ already has the audio content or right to access the audio content. If the second consumer 18′ does not have the audio content, then the consumer's audio player polls the reference service 5 for the distributor of the audio content to access to the audio content. The reference service 5 generates and sends an offer 11 back to the consumer 18′ based on electronic contracts 22 that act as a data source for the reference service 5. The electronic contracts 22 may include specific contracts and relationship information between the first consumer 18 and second consumer 18′, as well as additional contractual information such as analogous contracts that are relevant to creating the offer 11 by the reference service 5. The second consumer 18′ receives the offer 11 and is able to accept the offer 11, thereby completing an exchange-of-value transaction and gaining access to the audio content.

Reference services can also be used to create offers for the distribution of video content to consumers. FIG. 5 shows a table of product identifiers that may be used as reference data pointers to identify video and other content for distribution via value chain management objects. These reference data pointers may be included in value chain management objects, and thereby are included as part of the information for an exchange-of-value transaction. Product identifiers for video content can be easily distributed as reference data pointers to end consumers via e-mail, chat web pages and Interactive TV.

As shown in FIG. 5, a product ID 80 includes a unique identifier of the product by which the product is identified and sold, such as a single movie. A group ID 82 includes a unique identifier for a series of products, such as a series of movies, whereas an object ID 84 includes a unique identification for individual video elements, such as a trailer for a movie.

FIG. 6 shows a table of value chain identifiers, which include identification information for value chain participants, including those involved in the distribution of audio and video content. These value chain identifiers may be included as reference data pointers that are part of a value chain management object. Thus, value chain identifiers may be included in the terms of an exchange-of-value transaction and used to define the terms of such a transaction. As reference data pointers, value chain identifiers may be passed from one reference service to another.

Referring to FIG. 6, a distributor ID 90 includes unique identification information that identifies the owner or licensor of content, whereas the channel ID 92 includes unique identification information for point of acquisition or control of the content. A player ID 94 includes information about the individual or class of software or hardware that may play content and execute commercial offers for content. An instantiator ID 96 includes information about the creator of a data pointer and is used to increment a super distribution counter to keep track of super distributions, whereas a temporal ID 98 includes information about the temporal location of audio and video content, such as a time index for the video or audio content, and the status of the video or audio content, such as paused, playing, rewinding and fast forwarding.

For video content, additional meta information can be used to identify referenced video elements. Such meta information may be stored at a value chain participant or with a reference service. The meta information may be included in a value chain reference object as a reference data pointer, and may thereby be sent to a consumer as part of the terms of an exchange-of-value transaction.

Video content meta information may include background information about the video content such as its owner and creator, distributor, director, producer, composer, writers and actors. It may also include information about the video content itself such as its genre, date of release, series information, and running time. There may also be critical information about the movie such as its rating, awards, reviews, summaries and intended audience. Finally, there may be additional identification numbers and information for the video content. This meta information allows the consumer to identify video content they wish to use and may query reference services for an offer to purchase.

For offers involving video content, a consumer merely has to accept an offer to purchase, rent or access video content. The consumer then receives a reference data pointer that refers to the current or scheduled program and executes the content of the reference data pointer to access or receive the video content. For real-time video already in progress, the consumer may choose to join or record the video content, or select a later time to access the video content. For video content the consumer does not yet have access to, the consumer may choose to accept an offer to purchase, rent or subscribe to access to the video content. The consumer may also specify immediate access, or choose to access the video content at a later time via subscription or by recording its content. The consumer or distributor may also select specific options such as to omit advertising or to send targeted ads to the consumer.

Technical support can also be implemented using reference services and value chain management objects. For instance, a customer may notify a tech support representative via email or phone, and the representative may then diagnose the problem. If the problem cannot be solved immediately using a preexisting resource such as a help page or wizard, then a new resource can be created and sent to the customer using a reference data pointer. The customer opens the reference data pointer and accesses the tech representative's reference service to retrieve the necessary resources to solve the problem.

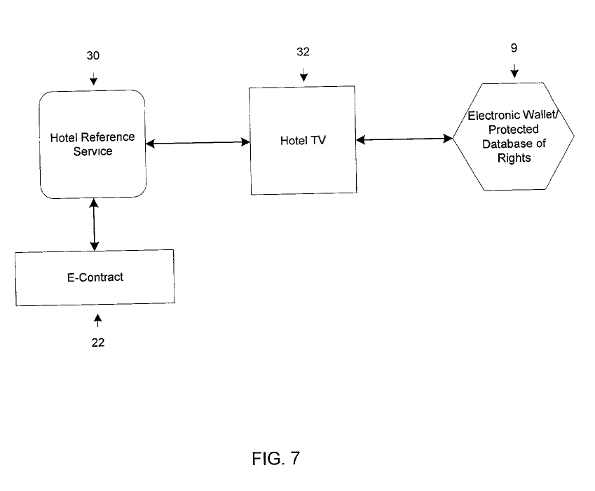

FIG. 7 is a block diagram illustrating the use of aggregation of services. The aggregation of services occurs when a plurality of reference services commnunicate with each other to create a value chain management object and send an offer to the customer. Each reference service acts as an agent to define new derivative contracts or offers based on relationships among parties and their corresponding value chain management objects. Thus, reference services are able to query each other in order to create a derivative contract or offer that represents the aggregation of the relationships between the value chain participants.

Referring now to FIG. 7, the hotel reference service 30 includes e-contracts 22 as a data source to generate offers for a hotel customer that communicates with the hotel TV 32. The e-contracts 22 may include information about specific past contracts between the hotel customer for whom the offer is being generated, and may also include general information about past contracts between other hotel customers that are used as a basis to generate an offer for the present hotel customer. The hotel customer may query the hotel reference service 30 for an offer, or the hotel reference service 30 may itself automatically generate an offer after sensing the hotel customer's interaction with the hotel TV 32.

The hotel reference service 30 creates a value chain management object that includes an offer based on the e-contract information 22, relevant information sent by the hotel customer to the hotel reference service 30, and any additional relevant information accessible to the hotel reference service 30 and relevant to generating the value chain management object. The hotel reference service 30 may also communicate with other reference services to aggregate the services of the hotel and other value chain participants. For instance, the hotel reference service 30 may communicate with the a customer's electronic wallet 9, which includes a reference service that describes the terms and discounts the customer is entitled to at the hotel. In this fashion, the hotel reference service 30 aggregates its services with that of the electronic wallet 9 to create a value chain management object. The value chain management object is then returned to the hotel customer through the hotel TV 32 and its reference service 30. The hotel customer reviews the offer included in the value chain management object and determines whether or not to accept the offer. The hotel customer then either accepts the offer and makes payment according to their preferences through the customer's electronic wallet and protected database of rights 9, or refuses the offer.

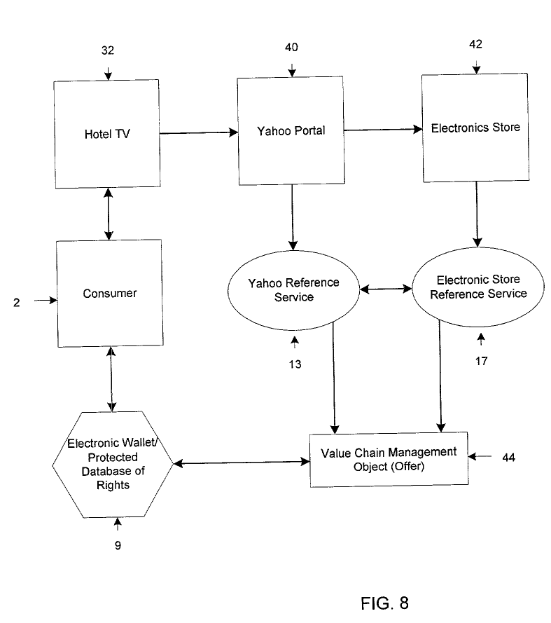

FIG. 8 is a block diagram illustrating the use of value chain information in a commercial transaction which also uses aggregation. In the transaction illustrated, a hotel traveler purchases to a Palm Pilot using Interactive TV by accepting a derivative offer for the Palm Pilot.

According to FIG. 8, a consumer 2 first arrives at a hotel, turns on their hotel TV 32, and inputs their user name and password to begin an Interactive TV session. The consumer 2 is a member of an airline club, and thus the airline is entitled to a 1% commission on any purchases made by the consumer 2 while in the hotel. In addition, the consumer 2 may also receive a discount for purchases made while in the hotel. When the consumer 2 begins an Interactive TV session, he initializes a local instance of his electronic wallet and protected database of rights 9.

The consumer 2 sees an advertisement for a Palm Pilot, decides to access an electronics store 42 in the Yahoo Mall via its Yahoo portal 40 to select an offer for the Palm Pilot. The reference service 17 for the electronics store 42 knows the location of the reference service 13 for the Yahoo portal 40, and is thereby able to create an aggregate offer by sending a value chain management object 44 to the consumer's electronic wallet 9. The consumer 2 decides to purchase the Palm Pilot and chooses to pay using his electronic wallet 9. The electronic wallet 9 queries the value chain management object 44, binds the relevant information to an offer from the value chain management object 44, and presents it to the consumer 2. The consumer 2 accepts the offer 44 and selects the method of delivery, thereby consummating an electronic contract for an exchange-of-value transaction.

In addition to the end parties of the transaction, which are the consumer 2 and the electronics store 42, the hotel, Yahoo, and the airline are also value chain participants that are party to the agreement. The hotel is party to the transaction through the hotel TV 32, and thus receives credit for part of the transaction. Yahoo is party to the transaction through the Yahoo portal 40 and its reference service 13 that facilitated the sale. The airline also receives its 1% commission on the sale. Thus, all value chain participants are credited for their involvement in the transaction, which is included in the terms of the offer agreed to by the consumer 2. The original value chain management object is passed from one reference service to another, aggregating terms according to the relationships between the value chain participants, and presenting those terms to the end consumer 2 for acceptance.

The functions performed by a personal reference service are similar to those general reference services, and thereby allow for similar functions by personal reference services. For instance, consumers enter into contractual relationships for credit cards, frequent flier programs, record club memberships, automobile associations, and trade associations. Consumers also prefer certain clothing stores, classes of travel, TV shows, formats for delivery of electronic goods, and delivery of physical goods. Consumers have personal information they intend to share or keep private, including bank information, social security numbers, addresses and phone numbers, address books and calendars, religious affiliations, and book lists and music preferences. Thus, a consumer's personal reference service is able to negotiate with other general reference services based on memberships, maintain anonymity, join other personal reference services to gain group benefits, and monitor offerings based on available choices.

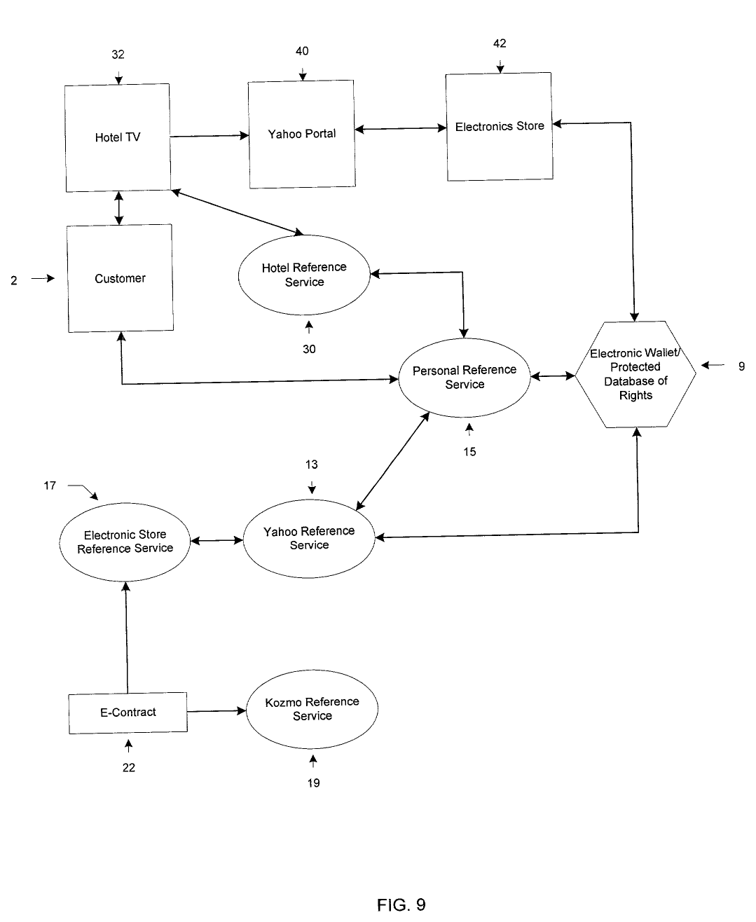

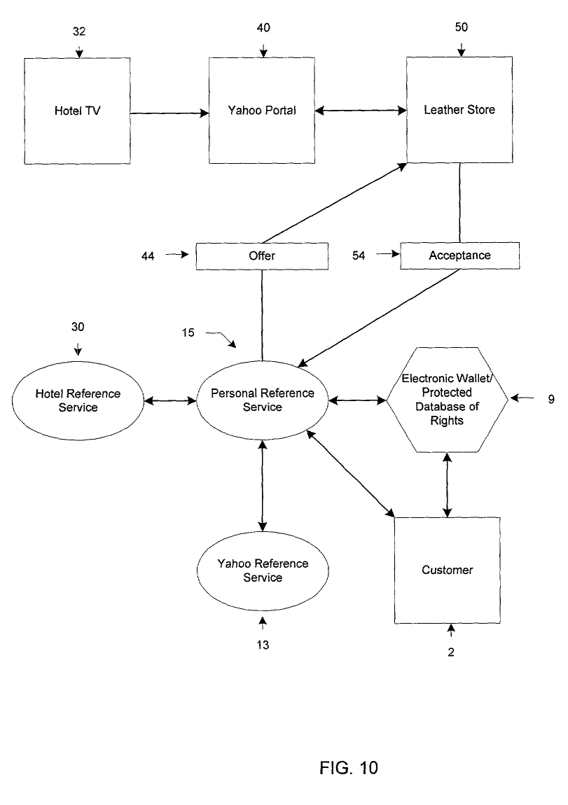

FIG. 9 is a block diagram illustrating the use of value chain information in another commercial transaction using affinity, retail, service and portal management. Affinity transactions reference a customer's personal reference service when creating offers for the customer.

As shown in FIG. 9, a customer 2, who is a traveler, registers in a hotel that has interactive shopping via Interactive TV 32. Thus, the customer 2 turns on their hotel TV 32 and registers the local electronic wallet 9 with their personal reference service 15 by notifying their personal reference service 15 that it may use the customer's local electronic wallet 9 for payment and delivery of any exchange-of-value transactions consummated by the customer 2.

After registering their local electronic wallet 9 with their personal reference service 15, the customer 2 then sees an advertisement for a Palm Pilot and clicks on the advertisement to access an electronics store 42 inside the Yahoo Mall through the Yahoo portal 40. The customer 2 selects a value chain management object as an offer, which includes a simple reference data pointer that identifies the customer, Yahoo and the object. The offer downloads to the customer's electronic wallet 9, which passes the offer to the customer's personal reference service 15. The personal reference service 15 queries the Yahoo reference service 13 about the offer, which queries the electronic store's reference service 17 about the offer. The customer's personal reference service 15 also queries the hotel reference service 30 about the offer. Thus, the Yahoo reference service 13, electronic store reference service 17 and hotel reference service 30 all generate terms and conditions for the offer to be sent to the hotel customer.

The results of these queries are added to the value chain management object that is stored in the customer's electronic wallet and database 9 at the hotel, and to a clearinghouse that is used to distribute the Palm Pilot. The customer 2 then decides to purchase the Palm Pilot by sending an offer from the electronic wallet 9 to the electronics store 42 for acceptance. The electronics store 42 accepts, and the customer 2 informs the hotel reference service 30 that the Palm Pilot should be delivered to the customer directly by Kozmo, which itself may be automatically notified to deliver the Palm Pilot via its own reference service 19. The customer posts the final accepted offer to the local electronic wallet 9 for resolution with the clearinghouse, which charges the cost of the Palm Pilot to the customer and deducts one Palm Pilot from its inventory. All value chain participants are paid by the clearinghouse, except Kozmo, which is paid by the hotel.

FIG. 10 is a block diagram illustrating the use of value chain information in a commercial transaction that includes offer and acceptance of the offer. In FIG. 10, a formal offer and acceptance occurs for a value chain management object that is generated by a plurality of value chain participants.

Referring now to FIG. 10, a hotel customer 2 communicates with the Internet through a hotel TV 32 and Yahoo portal 40, which provides the hotel customer 2 with access to the Internet. The hotel customer 2 registers their electronic wallet 9 locally through their personal reference service 15 in order to permit payment for any purchases made by the customer on the Internet through the Yahoo portal 40.

The customer views a product provided by a leather store 50 and queries their personal reference service 15 for an offer for the leather store product. The personal reference service 15 in turn communicates with the hotel reference service 30 and Yahoo reference service 13 in response to the customer's query. The personal reference service 15 also communicates with the leather store 50, and generates an offer 44 for the leather store 50 based on the information received from the hotel reference service 30, personal reference service 15 and Yahoo reference service 13. Thus, the offer 44 and its corresponding value chain management object originates with the customer 2 and their personal reference service 15 and is sent to the retail provider, which is the leather store 50 in this instance.

The leather store 50 responds with an acceptance 54 of the customer's offer, thereby consummating the exchange-of-value transaction between the customer 2 and the leather store 50. The customer's electronic wallet 9 is charged with the cost of the transaction, and the customer 2 is notified via the hotel TV 32 or other methods that the proposed offer has been accepted. The leather store 50 arranges for delivery of the product, thereby fulfilling the exchange-of-value transaction. Finally, Yahoo and the hotel take any additional commissions and other benefits from the transaction via the yahoo reference service 13 and hotel reference service 30, respectively.

While the invention has been particularly shown and described with reference to preferred embodiments thereof, it will be understood by those skilled in the art that various changes in form and details may be made therein without departing from the spirit and scope of the invention.

We claim:

1. A method for determining the terms of an exchange-of-value transaction, the method comprising the steps of:
requesting the terms of an exchange-of-value transaction by a requesting party;
identifying value chain participants to the exchange-of-value transaction whose relationship data affect the terms of the exchange-of-value transaction;
determining what relationship data from said value chain participants is relevant to the terms of the exchange-of-value transaction;
retrieving the relevant relationship data from said value chain participants;
applying derivation rules to said relevant relationship data to derive terms of the exchange-of-value transaction based on the relationships between said value chain participants;
adding additional terms to the exchange-of-value transaction that are not derived from said relationship data;
including all said derivative terms and said additional terms as the terms of the requested exchange-of-value transaction; and
returning said exchange-of-value transaction terms to a receiving party.

2. The method of claim 1, wherein said requesting party is an offer or who requests the terms of said exchange-of-value transaction, and wherein said terms of said exchange-of-value. transaction are sent from the offeror to an offeree as an offer to enter into an exchange-of-value transaction.

3. The method of claim 1, wherein said requesting party is an offeree who requests the terms of said exchange-of-value transaction, and wherein said offeree then uses said terms of said exchange-of-value transaction to accept, reject, or make a counter offer to a separate existing offer to enter into an exchange-of-value transaction.

4. The method of claim 1, wherein said requesting party requests said terms of said exchange-of-value transaction, and wherein said terms of said exchange-of-value transaction are then used by the requesting party to request an offer for an exchange-of-value transaction from an offeror.

5. The method of claim 1, wherein said value chain participants are express or implied parties to said exchange-of-value transaction.

6. The method of claim 1, wherein said relationship data is at least one of an explicit, express, contractual relationship between said value chain participants, an implicit, implied, desired relationship between said value chain participants, a direct or indirect relationship between said value chain participants, a formal or informal relationship between said value chain participants, a promotional relationship between said value chain participants, a relationship between and among a class of value chain participants, and a present, past or anticipated future relationship between said value chain participants.

7. The method of claim 1, wherein said derivation rules are dynamic and change based on said value chain participants and said relationship data, and wherein said derivation rules are static and remain constant regardless of said value chain participants and said relationship data.

8. The method of claim 1, wherein said additional terms are standard terms included by at least one of said value chain participants irrespective of said relationship data.

9. The method of claim 1, wherein said receiving party is an offeror that receives said exchange-of-value transaction terms as terms of a possible offer that said offeror may send to a value chain participant.

10. The method of claim 1, wherein said receiving party is an offeree that receives said exchange-of-value transaction terms as an offer to enter into an exchange-of-value transaction from a value chain participant.

11 The method of claim 1, wherein said receiving party is an offeree that receives said exchange-of-value transaction terms to verify the terms of a separate offer received from a value chain participant.

12. The method of claim 1, further comprising a reference service that includes, modifies, and applies said derivation rules to said relationship data to determine said derivative terms of said exchange-of-value transaction.

13. The method of claim 12, wherein said reference service requests and receives reference data from at least one additional reference service.

14. The method of claim 13, wherein said reference service applies said derivation rules to said requested and received reference data to derive said terms of said exchange-of-value transaction.

15. The method of claim 13, wherein said reference service includes said requested and received reference data as said terms for said exchange-of-value transaction.

16. The method of claim 1, wherein said derivative terms and said additional terms are referenced by reference data pointers.

17. The method of claim 16, wherein said reference data pointers are passed between said reference service and at least one additional reference service to communicate reference data between said reference service and said additional reference services.

18. The method of claim 16, wherein said reference data pointers include a distributor ID, object ID, retailer ID, player ID, instantiator ID and synch ID.

19. The method of claim 16, wherein said reference data pointers include product identifiers including a product ID, group ID and object ID.

20. The method of claim 16, wherein said reference data pointers include value chain identifiers including a distributor ID, channel ID, player ID, instantiator ID and temporal ID.

21. The method of claim 1, wherein said derivative terms and said additional terms are included in a value chain management object.

22. The method of claim 21, wherein said value chain management object comprises an offer, acceptance or transaction, and wherein said derivative terms and said additional terms comprise the terms of said offer, acceptance or transaction.

23. The method of claim 13, wherein said requested and received reference data is passed as a value chain management object.

24. The method of claim 1, wherein said relationship data is included in an electronic contract between value chain participants.

25. The method of claim 1, wherein said terms for said exchange-of-value transaction is for the purchase, licensing or access of audio, video and other electronic content.

26. The method of claim 25, wherein said request for said terms of said exchange-of-value transaction is initiated in response to the super distribution of said audio, video and other electronic content from one value chain participant to another.

27. The method of claim 1, wherein said requesting party is a producer for the purchase, licensing or access of audio, video and other electronic content.

28. The method of claim 27, wherein said receiving party is a consumer for the purchase, licensing or access of audio, video and other electronic contract.

29. The method of claim 28, wherein said terms of said exchange-of-value transaction are for said purchase, licensing or access of audio, video and other electronic content through an exchange-of-value transaction from said producer to said consumer, and wherein upon acceptance of said terms by said consumer, said consumer is able to download or access said audio, video and other electronic content.

30. The method of claim 1, wherein said requesting party is a consumer for the purchase, licensing or access of audio, video and other electronic content.

31. The method of claim 30, wherein said receiving party is a producer for the purchase, licensing or access of audio, video and other electronic contract.

32. The method of claim 31, wherein said terms of said exchange-of-value transaction are for said purchase, licensing or access of audio, video and other electronic content through an exchange-of-value transaction from said producer to said consumer, and wherein upon acceptance of said terms by said producer, said consumer is able to download or access said audio, video and other electronic content.

33. A computer with processing and data storage means performing a method for determining the terms of an exchange-of-value transaction, the method comprising the steps of
requesting the terms of an exchange-of-value transaction by a requesting party;
identifying value chain participants to the exchange-of-value transaction whose relationship data affect the terms of the exchange-of-value transaction;
determining what relationship data from said value chain participants is relevant to the terms of the exchange-of-value transaction;
retrieving the relevant relationship data from said value chain participants;
applying derivation rules to said relevant relationship data to derive terms of the exchange-of-value transaction based on the relationships between said value chain participants;
adding additional terms to the exchange-of-value transaction that are not derived from said relationship data;
including all said derivative terms and said additional terms as the terms of the requested exchange-of-value transaction; and
returning said exchange-of-value transaction terms to a receiving party.

34. An apparatus for determining the terms of an exchange-of-value transaction, comprising:
a processor;
a memory storing processing instructions for controlling the processor, the processor operative with the processing instructions to:
receive a request for the terms of an exchange-of-value transaction from a requesting party;
identify value chain participants to the exchange-of-value transaction whose relationship data affect the terms of the exchange-of-value transaction;
determine what relationship data from said value chain participants is relevant to the terms of the exchange-of-value transaction;
retrieve the relevant relationship data from said value chain participants;
apply derivation rules to said relevant relationship data to derive terms of the exchange-of-value transaction based on the relationships between said value chain participants;
add additional terms to the exchange-of-value transaction that are not derived from said relationship data;
include all said derivative terms and said additional terms as the terms of the requested exchange-of-value transaction; and
return said exchange-of-value transaction terms to a receiving party.

35. The apparatus of claim 34, said processor further including instructions for acting as a personal reference service, wherein said personal reference service may determine the derivative terms of an exchange-of-value transaction from relationship data stored in the personal reference service, and wherein said personal reference service may make payment for exchange-of-value transactions from the electronic wallet of the personal reference service.

36. The apparatus of claim 34, said processor further including instructions for sending, receiving, communicating and deriving the terms of an exchange-of-value transaction via the Internet and other electronic communication media.

37. The apparatus of claim 34, said processor further including instructions for sending, receiving, communicating and deriving the terms of an exchange-of-value transaction via Interactive TV.
